(19) United States
(12) Patent Application Publication
(10) Pub. No.: US 2024/0424368 A1
(43) Pub. Date: Dec. 26, 2024

(54) PICKLEBALL PADDLE WITH MULTI-FUNCTION HANDLE

(71) Applicant: Play Distributions, LLC, Foristell, MO (US)

(72) Inventor: Jason R. Hauk, Foristell, MO (US)

(21) Appl. No.: 18/675,356

(22) Filed: May 28, 2024

Related U.S. Application Data
(60) Provisional application No. 63/523,984, filed on Jun. 29, 2023.
(60) Provisional application No. 63/468,834, filed on May 25, 2023.

(51) Int. Cl. A63B 60/16; A63B 59/42; A63B 60/14; A63B 102/08; B67B 7/16; B67B 7/40; B67B 7/44

(52) U.S. Cl. CPC A63B 60/16; A63B 59/42; B67B 7/16; B67B 7/40; B67B 7/44; A63B 60/14; A63B 2102/08; A63B 2225/687

(57) ABSTRACT

A pickleball paddle having a multi-function handle. The paddle comprises a head having a front side, a back side, and a perimeter edge. The perimeter edge has a top edge, a bottom edge, a first lateral edge, and a second lateral edge. A central portion of each of the front and back sides is planar. A handle has a proximal end attached to the bottom edge of the head and extends downwardly from the bottom edge. A distal end of the handle includes a bottle opener and a can tab slot integrated therein. The handle also includes a female portion and a male portion that is removably received in the female portion in a mating relationship. The male portion has a can opener projection integrated therein configured for piercing a can.

### CROSS-REFERENCE TO RELATED APPLICATIONS

This application claims priority to U.S. Provisional Patent Application No. 63/468,834, filed May 25, 2023, and U.S. Provisional Patent Application No. 63/523,984, filed Jun. 29, 2023, the entire disclosures of which are incorporated herein by reference.

### BACKGROUND

Aspects of the present disclosure relate generally to a sports racquet and, particularly, to a pickleball paddle configured for impacting a ball and for facilitating the opening of a bottle or can.

Many racquet and paddle sports are engaged in as part of a social gathering. Such social gatherings provide participants the opportunity to play the sport and to enjoy the company of the other participants. During such social sports activities, it is common for the participants to take breaks, or to rotate in and out of play, to partake in and to enjoy beverages and other refreshments with other participants. During such events, it is common for players to enjoy bottled or canned beverages. Many bottled beverages are secured with metal bottle caps that are pleated or ruffled around the upper rim of the bottle. Such bottles typically require a bottle opener or other tool to remove the cap from the bottle. Bottle opening tools are small devices that are easily misplaced, lost, or forgotten. Accordingly, on many occasions, players engaging in social racquet sporting events can find themselves without a tool for removing caps from the bottles of beverages. Moreover, some players may have difficulty lifting the tab on a can due to finger mobility issues, weak and/or long fingernails, and so forth.

Accordingly, a need exists for a convenient way to ensure that players at social racquet or paddle sporting events do not find themselves without a device or tool for removing the caps from beverage bottles and opening canned beverages. It would be advantageous to provide a mechanism for ensuring that a social sporting event can be held with refreshments without having to remember to bring, carry, or obtain a tool for removing a cap from a beverage bottle or opening a beverage can.

### SUMMARY

Aspects of the present disclosure provide a sports racquet or paddle for impacting an object such as a game ball or shuttlecock and for facilitating the opening of a cap on a bottle or a tab on a can.

In an aspect, a game paddle configured for use while playing pickleball comprises a head having a front side, a back side, and a perimeter edge. The perimeter edge has a top edge, a bottom edge, a first lateral edge, and a second lateral edge. A central portion of each of the front and back sides is planar. A handle has a proximal end attached to the bottom edge of the head and extends downwardly from the bottom edge. A distal end of the handle includes a bottle opener and a can tab slot integrated therein.

In another aspect, a game paddle configured for use while playing pickleball comprises a head having a front side, a back side, and a perimeter edge. The perimeter edge has a top edge, a bottom edge, a first lateral edge, and a second lateral edge. A central portion of each of the front and back sides is planar. A handle has a proximal end attached to the bottom edge of the head and extends downwardly from the bottom edge. The handle includes a female portion and a male portion that is removably received in the female portion in a mating relationship. The male portion has a can opener projection integrated therein configured for piercing a can.

In yet another aspect, a racquet configured for use while playing a racquet sport comprises a head having a front side, a back side, and a perimeter edge. The perimeter edge has a top edge, a bottom edge, a first lateral edge, and a second lateral edge. A central portion of each of the front and back sides is configured for striking an object. A handle has a proximal end attached to the bottom edge of the head and extends downwardly from the bottom edge. The handle includes a female portion and a male portion. The male portion is removably received in the female portion in a mating relationship and has a can opener projection integrated therein configured for piercing a can. The male portion also has a bottle opener and a can tab slot integrated in a distal end thereof.

Other objects and features of the present invention will be in part apparent and in part pointed out herein.

### BRIEF DESCRIPTION OF THE DRAWINGS

FIG. 1 is a front perspective view of a paddle having a multi-function handle according to an embodiment.

FIG. 2 is a bottom perspective view of the paddle of FIG. 1 illustrating a bottle opener and can tab slot according to an embodiment.

FIG. 3 further illustrates the can tab slot according to an embodiment.

FIG. 4 is a bottom perspective view of the paddle of FIG. 1 illustrating a can opener projection according to an embodiment.

FIG. 5 is an exploded front perspective view of a paddle handle according to an embodiment.

FIG. 6 is an exploded side elevational view of the paddle handle of FIG. 5.

FIG. 7 is an exploded side elevational view of the paddle handle of FIG. 5 having portions removed.

FIG. 8 is perspective view of a butt cap for the paddle of FIG. 1 illustrating a bottle opener and can tab slot according to another embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

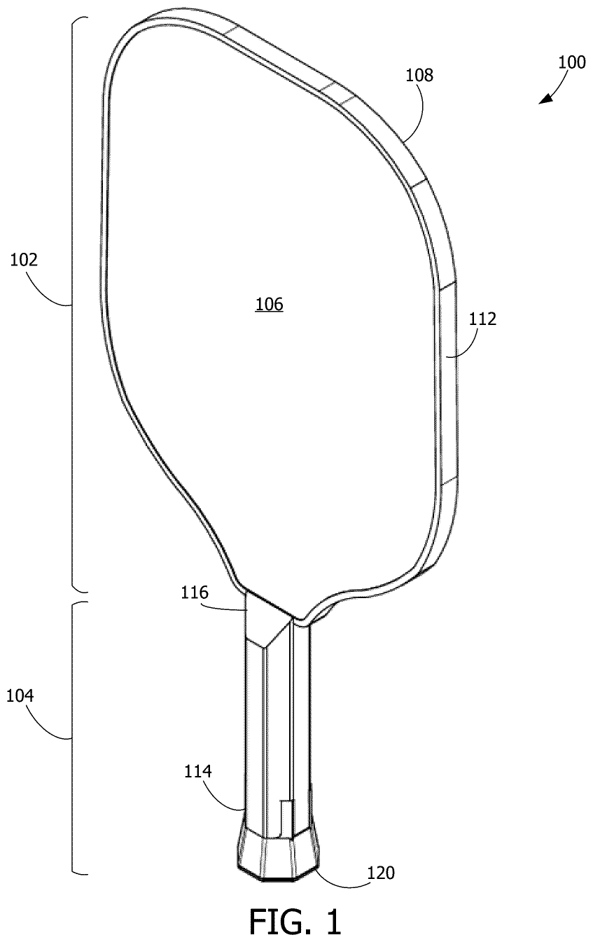

Referring to FIG. 1, a pickleball paddle is indicated generally at 100. The paddle 100 includes a head 102 coupled to a handle 104. The head 102 is a rigid planar structure configured for impacting an object such as a game ball. The head 102 includes a first planar surface 106, a second opposing planar surface 108, and an edging 112. In an embodiment, head 102 is approximately 7 to 8.25 inches wide and 15.5 to 17 inches in length and handle 104 is approximately 4 to 6 inches in length and 4 to 4.5 inches in circumference. In an embodiment, head 102 has a thickness measured from the first planar surface 106 to the second planar surface 108 of approximately 13 to 16 millimeters. In alternative embodiments, head 102 can be formed of other thicknesses.

In an embodiment, the first and second planar surfaces 106, 108 of head 102 can include alpha-numeric and/or graphical indicia, including one or more of trademarks, logos, symbols, patterns, designs, instructions, racquet design characteristics, advertisements, playing rules, warnings, and combinations thereof.

The edging 112 preferably extends about the periphery of the head 102 between the first and second planar surfaces 106, 108. The edging 112 can be integrally formed as part of the head 102 or can be applied to the head 102 as a separate structure. The edging 112 can have a thickness (or width) that is equal to the thickness of the head 102 measured from the first planar surface 106 to the second planar surface 108. The edging 112 is preferably formed of a tough, durable material, such as, a thermoplastic. Alpha-numeric and/or graphical indicia can also be applied to the outer surface of the edging. Alternatively, the edging 112 can be formed of other durable materials, such as for example, other plastic materials, a rubber, a thermoset material, a fiber composite material, a metallic alloy, wood and combinations thereof. The edging 112 can provide a flat, convex, or concave contour to the side or periphery of the head 102.

As is known in the art, the paddle 100 can be formed of various materials, including wood (e.g., maple, ash), plastic, graphite or carbon fiber, a composite, fiberglass, a metal or alloy (e.g., aluminum), or a combination of materials (e.g., a composite core with a carbon fiber hitting surface).

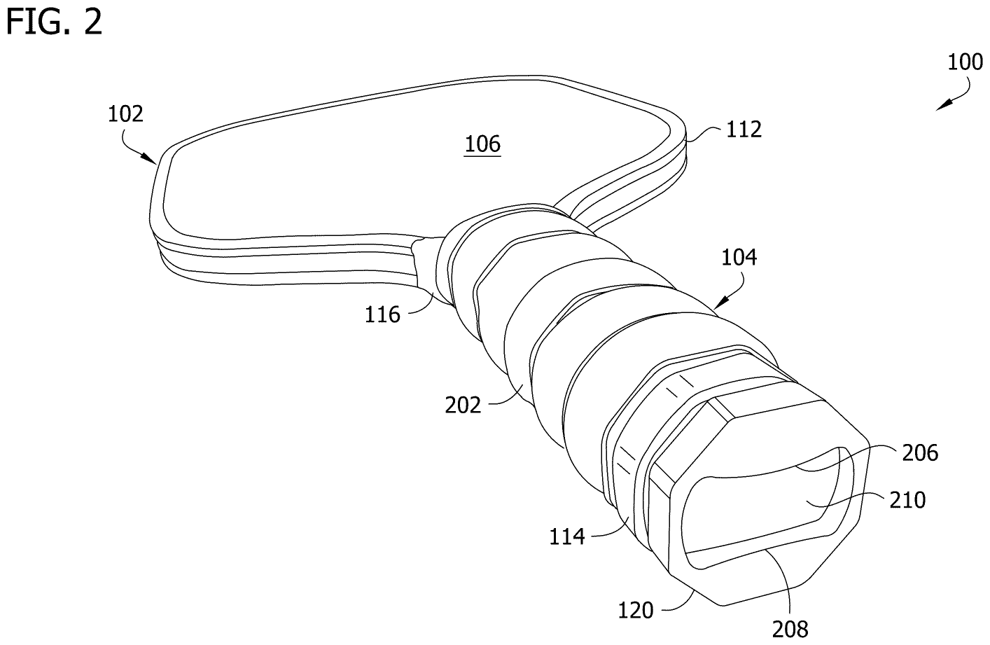

The handle 104 is a longitudinal tubular structure having a distal end 114 and a proximal end 116. The proximal end 116 of handle 104 is coupled to head 102. In one embodiment, handle 104 can be integrally formed with and connected to head 102 to form a one-piece frame. In an alternative embodiment, handle 104 can be formed separately from handle 104 and the proximal end 116 of handle 104 is coupled to head 102. FIG. 1 further illustrates a butt cap 120 at the distal end 114 of handle 104. The handle 104 is configured for grasping by one or more hands of a user during play and preferably includes a grip 202, as shown in FIG. 2, to enhance the ability of a player to grasp, hold, and manipulate paddle 100.

Referring to FIG. 2, a bottom perspective view of paddle 100 is shown, including the distal end 114 handle 104 and butt cap 120. In one or more embodiments, butt cap 120 is integrally formed with handle 104 as a single piece. In one or more alternative embodiments, the butt cap 120 may be formed separately and secured to handle 104. For example, butt cap 120 may be directly adhesively bonded to distal end 114. Alternatively, butt cap 120 may be thermally bonded, mechanically fastened, or otherwise directly attached to distal end 114. In another alternative embodiment, butt cap may be coupled to distal end 114 by an intermediate member or layer of material. As described in greater detail below, butt cap 120 may be coupled to distal end 114 by a threaded relationship.

In an embodiment, butt cap 120 can also include alpha-numeric and/or graphical indicia, including one or more of trademarks, logos, symbols, patterns, designs, instructions, racquet design characteristics, advertisements, playing rules, warnings, and combinations thereof.

A bottom face of butt cap 120 includes a recess 204 sized and shaped to receive a portion of a bottle cap on a bottle. The recess 204 is bounded by a rim having a lip 206 configured to catch a portion of an underside of the cap and a fulcrum 208 spaced apart from the lip 206 and configured to bear against the top of the cap as one or both of the handle 104 and the bottle serve as a lever for prying the cap off of the bottle. The lip 206 preferably projects toward the fulcrum 208 and extends over or into the recess 204. The lip 206 and/or the fulcrum 208 are preferably formed of a hard material, preferably a metallic alloy. Alternatively, the projection and/or the fulcrum can be formed of other materials, such as, for example, a fiber composite material, aluminum, a thermoplastic material, a thermoset material, a ceramic or combinations thereof.

As described above, recess 204 is configured to receive at least a portion of a cap of a bottle. The cap is typically formed of metal and covers an opening formed in the top of the bottle. The cap is typically affixed about a bottle rim by means of pleating. Once a portion of the cap is inserted within the recess 204 of butt cap 120, the lip 206 is configured to contact, catch, or otherwise operably engage an underside of the cap below the pleating. The fulcrum 208 is configured to operably engage the top of the cap when a player uses the bottle and/or the handle 104 of paddle 100 as one or more levers to pry the cap off of the bottle rim. The bottle and/or the handle 104 can be used by the user as a lever or levers to provide mechanical advantage to remove the cap from the bottle. The fulcrum 208 bears against, and enables a force to be applied to, the top of the cap thereby providing a pivot location for the cap relative to the bottle. The lip 206 and fulcrum 208 enable the handle 104 of paddle 100 to be used to quickly, efficiently and effectively remove a cap from a bottle.

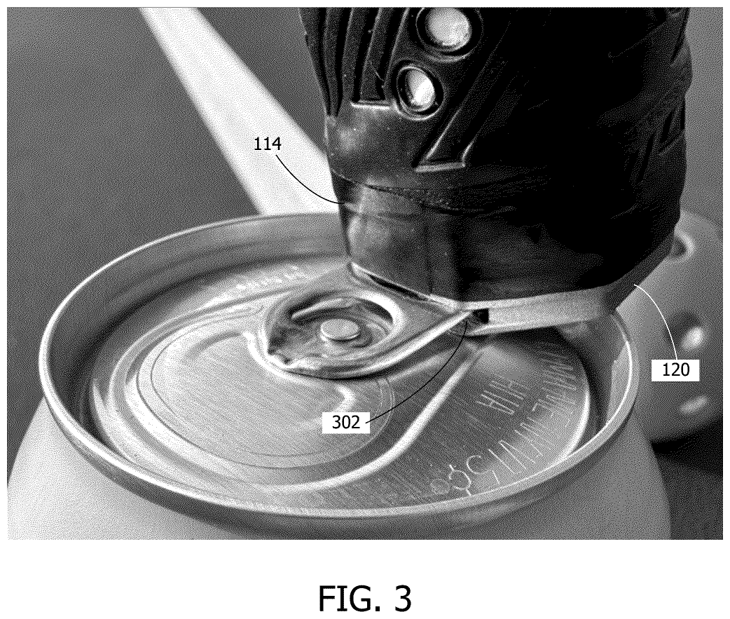

FIG. 3 illustrates a can tab slot 302 integrally formed in butt cap 120 according to an embodiment. As shown in FIG. 3, a side of butt cap 120 includes the slot 302 sized and shaped to receive a first portion of a tab secured to the top of a can (often referred to as a pop-top tab, pop tab, stay-on tab, or sta-tab). Once the first portion of the tab (e.g., about half) is received within slot 302, the handle 104 may then be used to lift the can tab. When lifted, the tab acts as a lever to force a second portion of the tab opposite the first portion downward, thus breaking a pre-scored metal sipping hole near the edge of the can top.

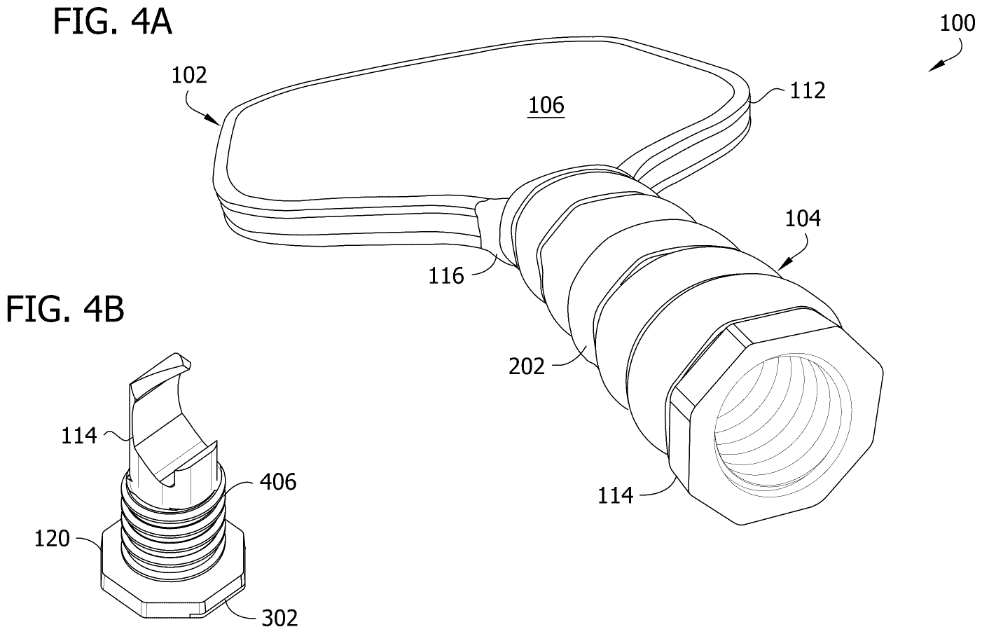

FIG. 4 is another bottom perspective view of paddle 100 in which butt cap 120 has been removed. The handle 104 of paddle 100 includes a female portion 404 and a male portion 406. In the illustrated embodiment, the butt cap 120 comprises the male portion 406 of handle 104 and includes a can opener projection 408 integrated therein. The can opener projection 408, or piercing tool, enables a player to easily pierce a can to provide an opening in addition to the one at the top of the can. For example, “shotgunning” is a means of consuming a beverage, commonly beer, very quickly by punching a hole in the side of the can, near the bottom, placing the mouth over the hole, and then pulling the tab to open the top. The male portion 406 is configured to be removably received in the female portion 404 in a mating relationship such that can opener projection 408 is stowed inside handle 104 when the male portion 406 is received in the female portion 404. Preferably, male portion 406 and female portion 404 have complementary threads such that male portion 406 may be screwed into female portion 404.

The multi-function handle 104 embodying aspects of the present disclosure is preferably made from a durable material, such as nylon, polymer, acrylic, plastic, acrylonitrile butadiene styrene (ABS), or metal (e.g., aluminum, stainless steel). In an embodiment, the handle 104 is constructed from a non-metal and includes a metal insert for added durability with less weight than a complete metal construction.

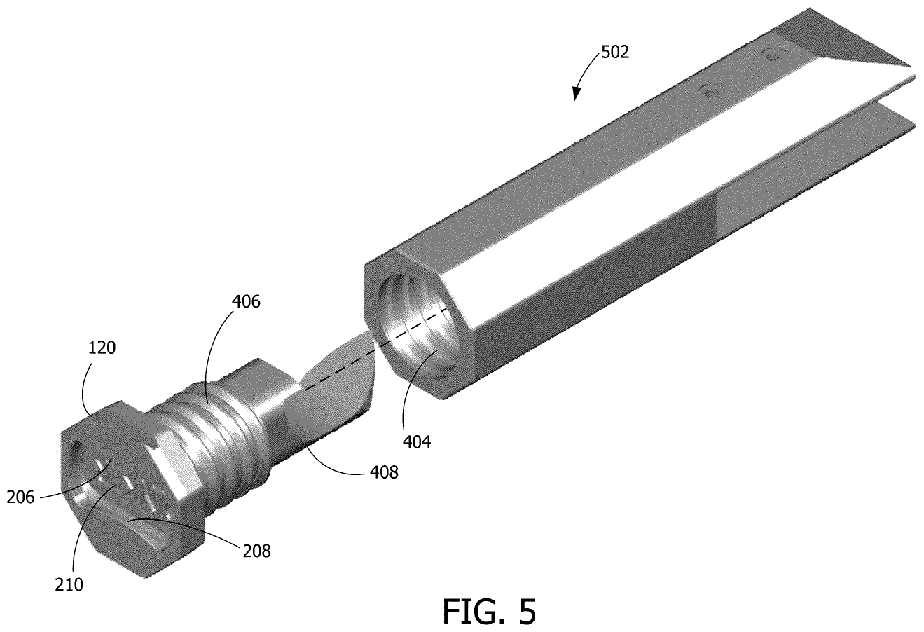

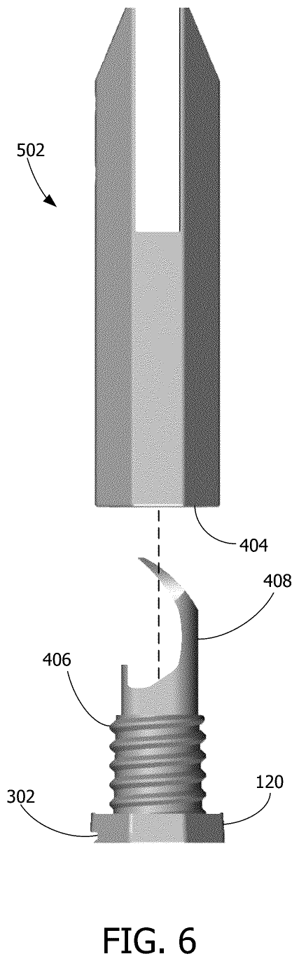

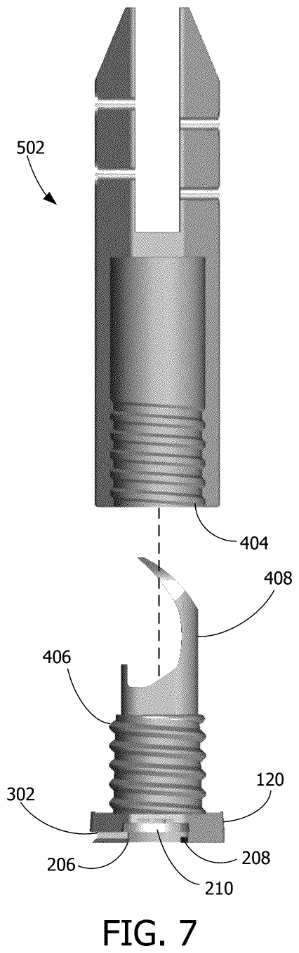

In an embodiment, handle 104 includes an insert 502 as shown in FIG. 5. In the illustrated embodiment, the insert 502 comprises the female portion 404 of handle 104. FIGS. 6 and 7 are exploded side elevational view of handle 104, including insert 502 and butt cap 120 embodying aspects of the present disclosure.

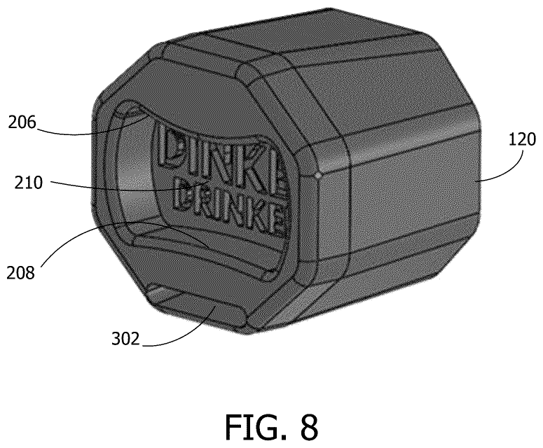

FIG. 8 is perspective view of butt cap 120 for the paddle 100 illustrating a bottle opener and can tab slot according to another embodiment. As shown, in this embodiment, the can tab slot 302 is oriented in the longitudinal direction of handle 104.

Although described herein in combination with a pickleball paddle, it is to be understood that aspects of the present disclosure may be incorporated into the handle of any sports racquet, including a pickleball paddle, tennis racquet, racquetball racket, badminton racquet, squash racquet, platform tennis racquet, paddle tennis racquet, padel tennis racquet, table tennis paddle, etc.

In an embodiment, a sleeve configured to securely fit over distal end 114 of the handle 104 includes a bottle opener on a distal end of the sleeve and the bottle opener includes a can tab slot integrated therein configured for receiving a tab of a can. The sleeve may be constructed of any durable material, such as neoprene.

The incorporation of aspects of the present disclosure improves a player's ability to enjoy racquet and paddle sports and the social gatherings commonly associated with the recreational play of such sports. The paddle described herein having a multi-function handle enables a user to play the racquet and paddle sports and also be equipped to remove caps from bottles and open cans during social gatherings associated with the activity.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A game paddle configured for use while playing pickleball, the paddle comprising:
a head having a front side, a back side, and a perimeter edge, the perimeter edge including a top edge, a bottom edge, a first lateral edge, and a second lateral edge, a central portion of each of the front and back sides being planar; and
a handle having a proximal end attached to the bottom edge of the head and extending downwardly therefrom;
wherein a distal end of the handle includes a bottle opener integrated therein and a can tab slot integrated therein.

2. The game paddle of claim 1, wherein the handle includes a female portion and a male portion, wherein the bottle opener and slot are integrated in the male portion, the male portion removably received in the female portion in a mating relationship, and the male portion having a can opener projection integrated therein configured for piercing a can.

3. The game paddle of claim 2, wherein the can opener projection is stowed inside the handle when the male portion is received in the female portion.

4. The game paddle of claim 2, wherein the female and male portions of the handle are threaded.

5. The game paddle of claim 1, wherein the bottle opener comprises a recess in the distal end of the handle, the recess being sized to removably receive a portion of a cap on a bottle.

6. The game paddle of claim 5, wherein the bottle opener comprises a plate partially covering the recess, the plate having a lip configured to catch a portion of an underside of the cap and a fulcrum configured to bear against the top of the cap as one or both of the handle and the bottle serve as a lever for prying the cap off of the bottle.

7. The game paddle of claim 1, wherein the can tab slot is configured for receiving a tab of a can and has an interior surface configured to bear against the tab as one or both of the handle and the can serve as a lever for prying the tab to open the can.

8. A game paddle configured for use while playing pickleball, the paddle comprising:
a head having a front side, a back side, and a perimeter edge, the perimeter edge including a top edge, a bottom edge, a first lateral edge, and a second lateral edge, a central portion of each of the front and back sides being planar; and
a handle having a proximal end attached to the bottom edge of the head and extending downwardly therefrom;
wherein the handle includes a female portion and a male portion, the male portion removably received in the female portion in a mating relationship, and the male portion having a can opener projection integrated therein configured for piercing a can.

9. The game paddle of claim 8, wherein a distal end of the handle includes a bottle opener integrated therein and a can tab slot integrated therein.

10. The game paddle of claim 9, wherein the bottle opener and the can tab slot are integrated in the male portion of the handle.

11. The game paddle of claim 10, wherein the bottle opener comprises a recess in a distal end of the male portion of the handle, the recess being sized to removably receive a portion of a cap on a bottle.

12. The game paddle of claim 11, wherein the bottle opener comprises a plate partially covering the recess, the plate having a lip configured to catch a portion of an underside of the cap and a fulcrum configured to bear against the top of the cap as one or both of the handle and the bottle serve as a lever for prying the cap off of the bottle.

13. The game paddle of claim 9, wherein the can tab slot is configured for receiving a tab of the can and has an interior surface configured to bear against the tab as one or both of the handle and the can serve as a lever for prying the tab to open the can.

14. The game paddle of claim 8, wherein the can opener projection is stowed inside the handle when the male portion is received in the female portion.

15. The game paddle of claim 8, wherein the female and male portions of the handle are threaded.

16. A racquet configured for use while playing a racquet sport, the racquet comprising:
a head having a front side, a back side, and a perimeter edge, the perimeter edge including a top edge, a bottom edge, a first lateral edge, and a second lateral edge, a central portion of each of the front and back sides being configured for striking an object; and
a handle having a proximal end attached to the bottom edge of the head and extending downwardly therefrom;
wherein the handle includes a female portion and a male portion, the male portion removably received in the female portion in a mating relationship, the male portion having a can opener projection integrated therein configured for piercing a can, and the male portion having a bottle opener and a can tab slot integrated in a distal end thereof.

17. The racquet of claim 16, wherein the can opener projection is stowed inside the handle when the male portion is received in the female portion.

18. The racquet of claim 16, wherein the female and male portions of the handle are threaded.

19. The racquet of claim 16, wherein the bottle opener comprises a recess in the distal end of the handle, the recess being sized to removably receive a portion of a cap on a bottle.

20. The racquet of claim 19, wherein the bottle opener comprises a plate partially covering the recess, the plate having a lip configured to catch a portion of an underside of the cap and a fulcrum configured to bear against the top of the cap as one or both of the handle and the bottle serve as a lever for prying the cap off of the bottle.

21. The racquet of claim 16, wherein the can tab slot is configured for receiving a tab of the can and has an interior surface configured to bear against the tab as one or both of the handle and the can serve as a lever for prying the tab to open the can.
